(19) United States
(12) Patent Application Publication
(10) Pub. No.: US 2026/0330340 A1
(43) Pub. Date: Oct. 22, 2026

(54) CARBON EMISSION FACTOR FORECASTING METHOD AND SYSTEM BASED ON MULTI-TIME GRANULARITY DATA COORDINATION

(71) Applicant: GUANGDONG POWER GRID CO., LTD., Guangzhou (CN)

(72) Inventors: Bo Peng, Guangzhou (CN); Xianfu Gong, Guangzhou (CN); Yaodong Li, Guangzhou (CN); Feng Li, Guangzhou (CN); Zhuoxing Chen, Guangzhou (CN); Ziqi Wang, Guangzhou (CN)

(21) Appl. No.: 19/646,560

(22) Filed: Apr. 14, 2026

Related U.S. Application Data
(63) Continuation-in-part of application No. PCT/CN2024/124879, filed on Oct. 15, 2024.

(30) Foreign Application Priority Data
Mar. 21, 2024 (CN) 202410323416.0

(51) Int. Cl. G06Q 10/04; G06Q 30/018

(52) U.S. Cl. CPC G06Q 10/04; G06Q 30/018

(57) ABSTRACT

Provided are a carbon emission factor forecasting method and system based on multi-time granularity data coordination. The carbon emission factor forecasting method includes: acquiring first carbon emission data of a to-be-forecast region, and establishing, based on a time granularity of the first carbon emission data, a plurality of initial first forecasting models for carbon emission factor forecasting, where each time granularity corresponds to one first forecasting model; establishing a time hierarchy matrix based on the time granularity and a to-be-forecast time period, and fusing the plurality of first forecasting models based on the time hierarchy matrix to obtain an initial first coordinated forecasting model; and updating a parameter of the first coordinated forecasting model based on the first carbon emission data, and obtaining a trained second coordinated forecasting model, so as to forecast a carbon emission factor through the second coordinated forecasting model.

### CROSS REFERENCE TO RELATED APPLICATIONS

The present application is a Continuation-In-Part Application of PCT Application No. PCT/CN2024/124879 filed on Oct. 15, 2024, which claims the benefit of Chinese Patent Application No. 202410323416.0 filed on Mar. 21, 2024. All the above are hereby incorporated by reference in their entirety.

### TECHNICAL FIELD

The present disclosure relates to the technical field of carbon emissions, and in particular, to a carbon emission factor forecasting method and system based on multi-time granularity data coordination.

### BACKGROUND

At present, in a process of accelerating development of a carbon market, economic incentive mechanisms are being used to encourage enterprises and organizations to reduce carbon emissions, thereby speeding up the achievement of the goals of carbon peaking and carbon neutrality. In this market, a carbon emission factor serves as an indicator for quantifying and evaluating a carbon emission level, thereby providing fundamental data and guidance for design and operation of the carbon market. Forecasting of the carbon emission factor allows market managers to understand changing trends of the carbon emission factor across different activities and industries, and formulate rational carbon emission caps and pricing mechanisms, thereby guiding and promoting emission reduction actions.

However, carbon emission factor data suffers from a time granularity problem. That is, the publicly released carbon emission factor is recorded on an annual basis, while local authorities may hold carbon emission factor data with a finer granularity (e.g., on a monthly basis). Therefore, if an existing carbon emission factor forecasting method is adopted to separately forecast data of different time granularities, resulting forecasting results are often inconsistent, that is, an aggregated fine-grained forecasting result is inconsistent with a coarse-grained forecasting result. As a result, the existing carbon emission factor forecasting method has low efficiency in utilizing the data of different time granularities, and often neglects a coupling relationship among time hierarchies, leading to low precision in a derived carbon emission factor.

### SUMMARY

An objective of the present disclosure is to address deficiencies in the above-mentioned existing related technologies by providing a carbon emission factor forecasting method and system based on multi-time granularity data coordination, so as to improve precision of a carbon emission factor.

According to a first aspect, the present disclosure provides a carbon emission factor forecasting method based on multi-time granularity data coordination, including:
acquiring first carbon emission data of a to-be-forecast region, and establishing, based on a time granularity of the first carbon emission data, a plurality of initial first forecasting models for carbon emission factor forecasting, where each time granularity corresponds to one first forecasting model;
establishing a time hierarchy matrix based on the time granularity and a to-be-forecast time period, and fusing the plurality of first forecasting models based on the time hierarchy matrix to obtain an initial first coordinated forecasting model;
updating a parameter of the first coordinated forecasting model based on the first carbon emission data, and obtaining a trained second coordinated forecasting model, so as to forecast a carbon emission factor through the second coordinated forecasting model; and
comparing the carbon emission factor with a preset threshold range, generating a corresponding control instruction based on a comparison result, and issuing the corresponding control instruction to a factory control system in the to-be-forecast region through an industrial control interface, so as to adjust an operating state of a production device in the to-be-forecast region.

The present disclosure separately establishes one forecasting model for each different time granularity, which can improve a utilization rate of multivariate time-series data. Furthermore, based on the time granularity and the to-be-forecast time period, the time hierarchy matrix is constructed to fuse a plurality of forecasting models. This can aggregate different fine-grained forecasting results, enhance an implicit impact of a coupling relationship among time hierarchies on the carbon emission factor forecasting, and build a self-consistent and coordinated carbon emission factor forecasting model. Therefore, consistent multi-time-hierarchy forecasting results can be formed, thereby improving precision of the carbon emission factor forecasting and laying a foundation for perception and analysis of changing trends of the carbon emission factor at different time scales.

Further, the generating a corresponding control instruction based on a comparison result includes:
when the forecasted carbon emission factor is greater than a first threshold, generating a first device shutdown instruction for controlling a production device with an energy consumption greater than an energy consumption threshold in the to-be-forecast region to stop operating; or when the forecasted carbon emission factor is less than a second threshold, generating a full-load operation instruction for controlling all production devices in the to-be-forecast region to operate at a full load.

Further, the fusing the plurality of first forecasting models based on the time hierarchy matrix to obtain an initial first coordinated forecasting model includes:
constructing an initial coordination matrix based on a quantity of forecast carbon emission factor values at a finest time granularity, acquiring an output matrix constituted by outputs of the plurality of first forecasting models, and constructing the initial first coordinated forecasting model in a dot product sequence of the time hierarchy matrix, the initial coordination matrix, and the output matrix.

The present disclosure fuses an output matrix constituted by outputs of a plurality of forecasting models by the time hierarchy matrix and a coordination matrix. This can aggregate forecasting results of different forecasting models, enhance the implicit impact of the coupling relationship among the time hierarchies on the carbon emission factor forecasting, and establish the self-consistent and coordinated carbon emission factor forecasting model, thereby improving the precision of the carbon emission factor forecasting.

Further, the constructing an initial coordination matrix based on a quantity of forecast carbon emission factor values at a finest time granularity includes:
constructing an identity matrix based on the quantity of forecast carbon emission factor values at the finest time granularity, constructing a zero matrix with the quantity of forecast carbon emission factor values as a row and a difference between a total quantity of forecast carbon emission factor values at all time granularities and the quantity of forecast carbon emission factor values as a column, and taking a block matrix constituted by the zero matrix and the identity matrix as the initial coordination matrix.

Further, the establishing a time hierarchy matrix based on the time granularity and a to-be-forecast time period includes:
if the time granularity includes an annual granularity, a quarterly granularity, and a monthly granularity, there are 3 time granularities; and if the to-be-forecast time period is next 12 months, the time hierarchy matrix is expressed as follows:

$$S = {( \begin{matrix}{S}_{Y} \\ {S}_{Q} \\ {S}_{M}\end{matrix} )}_{17 \times 12}$$

where

$${S}_{Y} = \frac{1}{12} {( 1 , … , 1 )}_{1 \times 12} ;$$

$${S}_{Q} = \frac{1}{4} {( \begin{matrix}{1}_{4} & 0 & 0 \\ 0 & ⋱ & 0 \\ 0 & 0 & {1}_{4}\end{matrix} )}_{4 \times 12} ,$$

1₄=(1, . . . , 1)_{1×4}; and S_{M}=I_{12×12}, where I represents an identity matrix.

The present disclosure establishes three time granularities (the annual granularity, the quarterly granularity, and the monthly granularity) and constructs, based on the to-be-forecast time period, the time hierarchy matrix constituted by these three granularities, so as to facilitate aggregation of different fine-grained forecasting results. This can improve the precision of the carbon emission factor forecasting, and enhance reliability and credibility of the carbon emission factor forecasting.

Further, the updating a parameter of the first coordinated forecasting model based on the first carbon emission data includes:
sequentially dividing second carbon emission data of the plurality of first forecasting models into a training set and a validation set proportionally, where the first carbon emission data includes second carbon emission data corresponding to each of the plurality of first forecasting models; and
updating an initial parameter of the first coordinated forecasting model and an initial coordination matrix based on the training set, the validation set, and a pre-constructed bi-level optimization model, where the bi-level optimization model includes a lower-level optimization model and an upper-level optimization model, the lower-level optimization model optimizes the initial parameter based on the training set to obtain an optimal parameter, and the upper-level optimization model optimizes the initial coordination matrix based on the validation set and the optimal parameter.

Further, the bi-level optimization model is expressed as follows:

$${min}_{G} {ℒ}^{val} ( \hat{θ} ( G ) )$$

$$s . t . \hat{θ} ( G ) = arg {min}_{{θ}^{[ 1 ]} , … , {θ}^{[ k ]}} {ℒ}^{train} ( {\hat{θ}}^{[ 1 ]} , … , {\hat{θ}}^{[ k ]} , G ) ,$$

where

$${ℒ}^{train} ( {\hat{θ}}^{[ 1 ]} , … , {\hat{θ}}^{[ k ]} , G ) = \frac{1}{\vert {D}_{i}^{train} \vert} {\sum }_{j = 1}^{\vert {D}_{i}^{train} \vert} {‖ {y}_{j , 1} - {\tilde{y}}_{1} ‖}_{2}^{2}$$

represents the lower-level optimization model;

$$\vert {D}_{i}^{train} \vert$$

represents a quantity of training set samples of an i^{th} first forecasting model, where i=1, 2, . . . , k; y_{j,1} represents an actual load of a j^{th} training sample; G represents the initial coordination matrix; \hat{θ}=(\hat{θ}^{[1]}, . . . , \hat{θ}^{[k]}) represents an initial parameter set of a k^{th} first forecasting model; \tilde{y}₁ represents a forecasting result obtained by inputting the training set into the first coordinated forecasting model;

$${ℒ}^{val} ( \hat{θ} ( G ) ) = \frac{1}{\vert {D}_{i}^{val} \vert} {\sum }_{j = 1}^{\vert {D}_{i}^{val} \vert} {‖ {y}_{j , 2} - {\tilde{y}}_{2} ‖}_{2}^{2}$$

represents the upper-level optimization model; \tilde{y}₂ represents a forecasting result obtained by inputting a test set into the first coordinated forecasting model;

$$\vert {D}_{i}^{val} \vert$$

represents a quantity of validation set samples of the i^{th} first forecasting model; and y_{j,2} represents an actual load of a j^{th} validation sample.

Further, the sequentially dividing second carbon emission data of the plurality of first forecasting models into a training set and a validation set proportionally includes:
sequentially performing feature screening on the second carbon emission data of the plurality of first forecasting models, obtaining a feature screening result, dividing the feature screening result into a training set, a validation set, and a test set proportionally, and performing column-wise normalization on the training set, the validation set, and the test set to obtain a normalized training set, a normalized validation set, and a normalized test set respectively, so as to finally perform training, validation, and testing based on the normalized training set, the normalized validation set, and the normalized test set respectively, where each of the plurality of first forecasting models corresponds to one normalized training set, one normalized validation set, and one normalized test set.

Further, the performing testing based on the normalized test set includes:
respectively inputting a plurality of normalized test sets into corresponding second forecasting models after optimization of the plurality of first forecasting models, respectively outputting corresponding forecasting results based on optimal parameters obtained after the optimization, inputting the forecasting results into the second coordinated forecasting model, and outputting a total forecasting result based on an optimal coordination matrix obtained after the optimization; and
evaluating forecasting precision of each of the second forecasting models based on an actual load of each of the plurality of normalized test sets and the total forecasting result.

Further, the evaluating forecasting precision of each of the second forecasting models includes:
taking a mean absolute percentage error (MAPE) as an evaluation indicator of the forecasting precision of the second forecasting model, where the evaluation indicator is expressed as follows:

$$MAPE ( {\tilde{y}}^{[ i ]} , {y}^{[ i ]} ) = \frac{1}{\vert {D}_{i}^{test} \vert \cdot T} {\sum }_{j = 1}^{\vert {D}_{i}^{test} \vert} {\sum }_{t = 1}^{T} \vert \frac{{y}_{j , t}^{[ i ]} - {\tilde{y}}_{j , t}^{[ i ]}}{{y}_{j , t}^{[ i ]}} \vert \times 100 \% ,$$

where
j represents a serial number of a test sample, t represents a serial number of a time point in the to-be-forecast time period,

$${\tilde{y}}_{j , t}^{[ i ]}$$

represents a forecasting result of the normalized test set,

$${y}_{j , t}^{[ i ]}$$

represents an actual load corresponding to the test sample,

$$\vert {D}_{i}^{test} \vert$$

represents a quantity of test set samples of an i^{th} second forecasting model, and T represents a total quantity of time points in the to-be-forecast time period.

According to a second aspect, the present disclosure provides a carbon emission factor forecasting system based on multi-time granularity data coordination, including: a forecasting model establishment module, a coordinated forecasting model establishment module, a training module, and an instruction generation module, where
the forecasting model establishment module is configured to acquire first carbon emission data of a to-be-forecast region, and establish, based on a time granularity of the first carbon emission data, a plurality of initial first forecasting models for carbon emission factor forecasting, where each time granularity corresponds to one first forecasting model;
the coordinated forecasting model establishment module is configured to establish a time hierarchy matrix based on the time granularity and a to-be-forecast time period, and fuse the plurality of first forecasting models based on the time hierarchy matrix to obtain an initial first coordinated forecasting model;
the training module is configured to update a parameter of the first coordinated forecasting model based on the first carbon emission data, and obtain a trained second coordinated forecasting model, so as to forecast a carbon emission factor through the second coordinated forecasting model; and
the instruction generation module is configured to compare the carbon emission factor with a preset threshold range, generate a corresponding control instruction based on a comparison result, and issue the corresponding control instruction to a factory control system in the to-be-forecast region through an industrial control interface, so as to adjust an operating state of a production device in the to-be-forecast region.

### BRIEF DESCRIPTION OF THE DRAWINGS

FIG. 1 is a schematic flowchart of a carbon emission factor forecasting method based on multi-time granularity data coordination according to an embodiment;

FIG. 2 is a schematic diagram of a coordinated forecasting model according to an embodiment;

FIG. 3 is a complete schematic flowchart of a carbon emission factor forecasting method based on multi-time granularity data coordination according to an embodiment; and

FIG. 4 is a schematic structural diagram of a carbon emission factor forecasting system based on multi-time granularity data coordination according to an embodiment.

### DETAILED DESCRIPTION

The technical solutions in the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

It is worth noting that the present disclosure is intended to overcome deficiencies in the prior art by providing a carbon emission factor forecasting method and system based on multi-time granularity data coordination. Firstly, a carbon emission factor status of a to-be-forecast region is investigated, different to-be-forecast time granularities are determined, and a time hierarchy matrix is established. Secondly, a carbon emission factor forecasting model and a time hierarchy coordination model are constructed. Thirdly, a dataset is preprocessed, and a forecasting model and a coordination matrix are updated to obtain a fitted multi-time granularity carbon emission factor forecasting model. Finally, precision of carbon emission factor forecasting at different time granularities is calculated, and forecasting performance is evaluated. The present disclosure helps address difficulty and incoordination in the carbon emission factor forecasting at different time granularities, thereby improving the precision of the carbon emission factor forecasting. The technical solutions of the present disclosure are further described in detail below with reference to the following embodiments.

### Embodiment 1

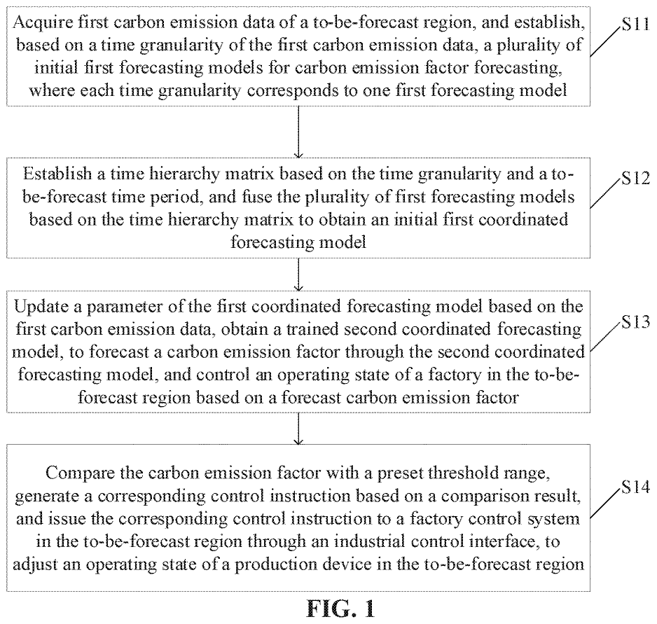

FIG. 1 is a schematic flowchart of a carbon emission factor forecasting method based on multi-time granularity data coordination according to this embodiment. The carbon emission factor forecasting method specifically includes the following steps S11 to S13:

Step S11: Acquire first carbon emission data of a to-be-forecast region, and establish, based on a time granularity of the first carbon emission data, a plurality of initial first forecasting models for carbon emission factor forecasting, where each time granularity corresponds to one first forecasting model.

In some embodiments, carbon emission data of the to-be-forecast region is acquired, a change of a carbon emission factor is analyzed, and k different to-be-forecast time granularities and a to-be-forecast time period are determined in combination with expert advice, where k is a positive integer.

It is worth noting that the first carbon emission data is historical carbon emission data of the to-be-forecast region, and a first forecasting model is an initial forecasting model corresponding to one time granularity.

In some embodiments, a time hierarchy matrix is established based on the time granularity and the to-be-forecast time period, which includes: if the time granularity includes an annual granularity, a quarterly granularity, and a monthly granularity, there are k=3 time granularities; and if the to-be-forecast time period is next 12 months, the time hierarchy matrix is expressed as follows:

$$S = {( \begin{matrix}{S}_{Y} \\ {S}_{Q} \\ {S}_{M}\end{matrix} )}_{17 \times 12}$$

where

$${S}_{Y} = \frac{1}{12} {( 1 , … , 1 )}_{1 \times 12} ;$$

$${S}_{Q} = \frac{1}{4} {( \begin{matrix}{1}_{4} & 0 & 0 \\ 0 & ⋱ & 0 \\ 0 & 0 & {1}_{4}\end{matrix} )}_{4 \times 12} ,$$

1₄=(1, . . . , 1)_{1×4}; and S_{M}=I_{12×12}, where I represents an identity matrix.

In some embodiments, the time hierarchy matrix

$$S = {( {S}_{ij} )}_{n \times m} = ( \begin{matrix}{S}_{k} \\ ⋮ \\ {S}_{1}\end{matrix} )$$

is constructed based on a selected time granularity and time period, where n represents a quantity of forecast values at all time granularities in all time periods, and m represents a quantity of forecast values at a finest time granularity. The time hierarchy matrix S can be written as k block matrices Sₖ, and each block matrix represents a weight for constructing a forecasting of a k^{th} target time granularity using the forecast values at the finest time granularity. If a forecast carbon emission factor at the finest time granularity is known as

$${\hat{y}}^{[ 1 ]} = {( {\hat{y}}_{t + 1}^{[ 1 ]} , … , {\hat{y}}_{t + N}^{[ 1 ]} )}^{T} ,$$

where N represents a total quantity of forecast points at the finest time granularity, an overall forecasting at all the time granularities can be expressed as ŷ=Sŷ^{[1]}=((Sₖŷ^{[1]})^{τ}, . . . , (S₁ŷ^{[1]})^{τ})^{T}=((ŷ^{[k]})^{τ}, . . . , (ŷ^{[1]})^{τ})^{τ}, where τ represents transposition.

In some embodiments, based on the selected time granularity and to-be-forecast duration, corresponding input feature spaces
[symbol] ₁, . . . , [symbol] ₖ and output spaces [symbol] ₁, . . . , [symbol] ₖ can be respectively determined for carbon emission factor forecasting models at the k time granularities.

Accordingly, carbon emission factor forecasting models at different time granularities can be expressed as follows:

y^{[i]}=fᵢ(x^{[i]};θ^{[i]})+ϵᵢ,i=1,2, . . . ,k, where

(x^{[i]}; θ^{[i]})∈ [symbol] ᵢ× [symbol] ᵢ represents input and output data of a forecasting model at an i^{th} time granularity; fᵢ represents an i^{th} parameterized neural network regression model with a trainable parameter being θ^{[i]}; and ϵᵢ represents an error term.

In some embodiments, if the fᵢ is fitted by adjusting its parameter θ^{[i]} to finally obtain \hat{θ}^{[i]}, a forecast carbon emission factor value that is obtained is as follows:

ŷ^{[i]}=fᵢ(x^{[i]};\hat{θ}^{[i]}), i=1,2, . . . ,k.

Step S12: Establish the time hierarchy matrix based on the time granularity and the to-be-forecast time period, and fuse the plurality of first forecasting models based on the time hierarchy matrix to obtain an initial first coordinated forecasting model.

In some embodiments, the fusing the plurality of first forecasting models based on the time hierarchy matrix to obtain an initial first coordinated forecasting model includes: constructing an initial coordination matrix based on a quantity of forecast carbon emission factor values at the finest time granularity, acquiring an output matrix constituted by outputs of the plurality of first forecasting models, and constructing the initial first coordinated forecasting model in a dot product sequence of the time hierarchy matrix, the initial coordination matrix, and the output matrix.

It is worth noting that the first coordinated forecasting model is an initial coordinated forecasting model established based on the time hierarchy matrix, a plurality of forecasting models, and a coordination matrix. The initial coordination matrix and an optimal coordination matrix are respectively the initial coordination matrix and an optimized optimal coordination matrix.

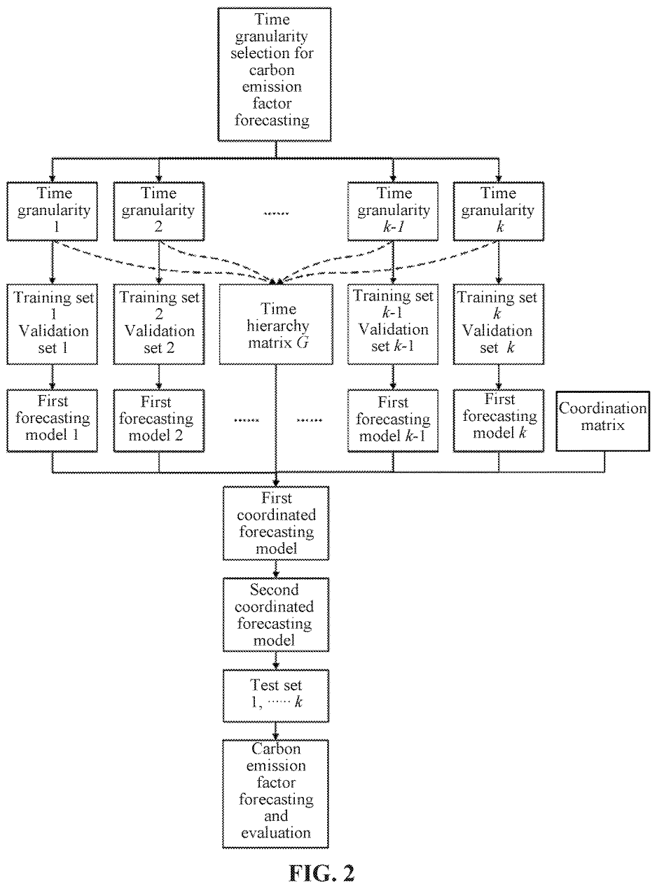

In some embodiments, FIG. 2 is a schematic diagram of a coordinated forecasting model provided in this embodiment. In FIG. 2, one first forecasting model is separately established for each time granularity, and the time hierarchy matrix is constructed based on the time granularity and the to-be-forecast time period. The first coordinated forecasting model is established based on the plurality of first forecasting models, the coordination matrix, and the time hierarchy matrix. When a parameter of the coordinated forecasting model is updated, a parameter of the first forecasting model and the coordination matrix are essentially updated to obtain a second coordinated forecasting model.

In some embodiments, an output matrix ŷ=((ŷ^{[k]})^{τ}, . . . , (ŷ^{[1]})^{τ})^{τ} constituted by carbon emission factors output by the plurality of first forecasting models can be obtained by aggregating forecasting results of k first forecasting models, where (ŷ^{[k]}) represents a carbon emission factor forecasting result of a k^{th} first forecasting model, and τ represents the transposition. Subsequently, the first coordinated forecasting model is constructed by combining the output matrix ŷ, the time hierarchy matrix S, and the coordination matrix, which can be expressed as follows:

\tilde{y}=SG\tilde{y}, where

G=(Gᵢⱼ)_{m×n} represents the coordination matrix. If G=G₀=(0 I_{m×m}), it means that only finest-grained forecasting results ŷ^{[1]} are aggregated layer by layer till coarsest-grained forecasting is obtained, which represents a simplest initial coordination matrix. The G can be understood as a hyperparameter used to adjust the output matrix ŷ of the plurality of first forecasting models. A finally coordinated overall forecasting result is obtained, namely \tilde{y}.

In some embodiments, the constructing an initial coordination matrix based on a quantity of forecast carbon emission factor values at the finest time granularity includes: constructing an identity matrix based on the quantity of forecast carbon emission factor values at the finest time granularity, constructing a zero matrix with the quantity of forecast carbon emission factor values as a row and a difference between a total quantity of forecast carbon emission factor values at all the time granularities and the quantity of forecast carbon emission factor values as a column, and taking a block matrix constituted by the zero matrix and the identity matrix as the initial coordination matrix.

Step S13: Update a parameter of the first coordinated forecasting model based on the first carbon emission data, and obtain a trained second coordinated forecasting model, so as to forecast the carbon emission factor through the second coordinated forecasting model.

Step S14: Compare the carbon emission factor with a preset threshold range, generate a corresponding control instruction based on a comparison result, and issue the corresponding control instruction to a factory control system in the to-be-forecast region through an industrial control interface, so as to adjust an operating state of a production device in the to-be-forecast region.

In some embodiments, the updating a parameter of the first coordinated forecasting model based on the first carbon emission data includes: sequentially dividing second carbon emission data of the plurality of first forecasting models into a training set and a validation set proportionally, where the first carbon emission data includes second carbon emission data corresponding to each of the plurality of first forecasting models; and updating an initial parameter of the first coordinated forecasting model and an initial coordination matrix based on the training set, the validation set, and a pre-constructed bi-level optimization model, where the bi-level optimization model includes a lower-level optimization model and an upper-level optimization model, the lower-level optimization model optimizes the initial parameter based on the training set to obtain an optimal parameter, and the upper-level optimization model optimizes the initial coordination matrix based on the validation set and the optimal parameter.

It is worth noting that the second carbon emission data is carbon emission data used by each forecasting model. The second carbon emission data has different time scales based on different time granularities. The second coordinated forecasting model is a coordinated forecasting model obtained after training the initial first coordinated forecasting model.

In some embodiments, the sequentially dividing second carbon emission data of the plurality of first forecasting models into a training set and a validation set proportionally includes: sequentially performing feature screening on the second carbon emission data of the plurality of first forecasting models, obtaining a feature screening result, dividing the feature screening result into a training set, a validation set, and a test set proportionally, and performing column-wise normalization on the training set, the validation set, and the test set to obtain a normalized training set, a normalized validation set, and a normalized test set respectively, so as to finally perform training, validation, and testing based on the normalized training set, the normalized validation set, and the normalized test set respectively, where each of the plurality of first forecasting models corresponds to one normalized training set, one normalized validation set, and one normalized test set.

In some embodiments, based on an input space and an output space, namely [symbol] ᵢ, [symbol] ᵢ, a total dataset

$${D}_{i} = \{ ( {x}_{j}^{[ i ]} , {y}_{j}^{[ i ]} ) ∈ {𝒳}_{i} \times {𝒴}_{i} , j = 1 , … , \vert {D}_{i} \vert \}$$

at the i^{th} time granularity can be constructed from a carbon emission factor dataset. Subsequently, the Dᵢ is divided into a training set

$${D}_{i}^{train} ,$$

a validation set

$${D}_{i}^{val} ,$$

and a test set

$${D}_{i}^{test}$$

based on a proportion of 8:2:2 in a chronological order. Then, input data needs to be normalized, and a normalization method is as follows:

$$x = \frac{\tilde{x} - {x}_{m i n}}{{x}_{m ax} - {x}_{m i n}} ,$$

where

xₘᵢₙ represents a minimum value of a column vector, xₘₐₓ represents a maximum value of the column vector, and \tilde{x} and x respectively represent elements in the column vector before and after the normalization.

In some embodiments, the above normalization method is applied to a variable of each column in the global training set. Maximum and minimum values of each column in the training set are memorized and applied to the same normalization method for the validation set and the test set. Therefore, a global dataset after data preprocessing can be obtained.

In some embodiments, a training set loss function

$${ℒ}_{i}^{train}$$

and a validation set loss function [symbol] ^{val} are separately defined, and the bi-level optimization model is established:

$${ℒ}^{train} ( {θ}^{[ 1 ]} , … , {θ}^{[ k ]} , G ) = \frac{1}{\vert {D}_{i}^{train} \vert} {\sum }_{j = 1}^{\vert {D}_{i}^{train} \vert} {‖ {y}_{j} - SG \hat{y} ‖}_{2}^{2} ,$$

where

$$\vert {D}_{i}^{train} \vert$$

represents a quantity of training set samples at the i^{th} time granularity. When the coordination matrix G is given, a corresponding optimal forecasting model parameter \hat{θ}=(\hat{θ}^{[1]}, . . . , \hat{θ}^{[k]}) can be expressed as follows:

$$\hat{θ} ( G ) = arg {min}_{{θ}^{[ 1 ]} , … , {θ}^{[ k ]}} {ℒ}^{train} ( {θ}^{[ 1 ]} , … , {θ}^{[ k ]} , G ) .$$

In some embodiments, the coordination matrix G can be interpreted as the hyperparameter, and thus can be adjusted based on the validation set loss function [symbol] ^{val} on the validation set:

$${ℒ}^{val} ( \hat{θ} ( G ) ) = \frac{1}{\vert {D}_{i}^{val} \vert} {\sum }_{j = 1}^{\vert {D}_{i}^{val} \vert} {‖ {y}_{j} - SG \hat{y} ‖}_{2}^{2} ,$$

where

$$\vert {D}_{i}^{val} \vert$$

represents a quantity of validation set samples at the i^{th} time granularity.

It is worth noting that, based on the time granularity, the carbon emission data is divided into k sets, and one first forecasting model is established for each carbon emission data set. That is, one time granularity corresponds to one first forecasting model, and the i^{th} time granularity refers to an i^{th} first forecasting model.

In some embodiments, the bi-level optimization model is expressed as follows:

$${min}_{G} {ℒ}^{val} ( \hat{θ} ( G ) ) \\ s . t . \\ \hat{θ} ( G ) = arg {min}_{{θ}^{[ 1 ]} , … , {θ}^{[ k ]}} {ℒ}^{train} ( {θ}^{[ 1 ]} , … , {θ}^{[ k ]} , G ) , \\ where \\ {ℒ}^{train} ( {θ}^{[ 1 ]} , … , {θ}^{[ k ]} , G ) = \frac{1}{\vert {D}_{i}^{train} \vert} {\sum }_{j = 1}^{\vert {D}_{i}^{train} \vert} {‖ {y}_{j , 1} - {\tilde{y}}_{1} ‖}_{2}^{2}$$

represents the lower-level optimization model;

$$\vert {D}_{i}^{train} \vert$$

represents a quantity of training set samples of the i^{th} first forecasting model, where i=1, 2, . . . , k; y_{j,1} represents an actual load of a j^{th} training sample; G represents the initial coordination matrix; \hat{θ}=(\hat{θ}^{[1]}, . . . , \hat{θ}^{[k]}) represents an initial parameter set of the k^{th} first forecasting model; \tilde{y}₁ represents a forecasting result obtained by inputting the training set into the first coordinated forecasting model;

$${ℒ}^{val} ( \hat{θ} ( G ) ) = \frac{1}{\vert {D}_{i}^{val} \vert} {\sum }_{j = 1}^{\vert {D}_{i}^{val} \vert} {‖ {y}_{j , 2} - {\tilde{y}}_{2} ‖}_{2}^{2}$$

represents the upper-level optimization model; \tilde{y}₂ represents a forecasting result obtained by inputting the test set into the first coordinated forecasting model;

$$\vert {D}_{i}^{val} \vert$$

represents a quantity of validation set samples of the i^{th} first forecasting model; and y_{j,2} represents an actual load of a j^{th} validation sample.

It is worth noting that lower-level optimization aims to provide an optimal parameter set \hat{θ}(G) of a carbon emission factor forecasting model for the given coordination matrix G based on a loss of the training set; and upper-level optimization aims to adjust the coordination matrix G based on a loss of the validation set, thereby jointly optimizing forecasting model parameters and the coordination matrix.

In some embodiments, the performing testing based on the normalized test set includes: respectively inputting a plurality of normalized test sets into corresponding second forecasting models after optimization of the plurality of first forecasting models, respectively outputting corresponding forecasting results based on optimal parameters obtained after the optimization, inputting the forecasting results into the second coordinated forecasting model, and outputting a total forecasting result based on an optimal coordination matrix obtained after the optimization; and evaluating forecasting precision of each of the second forecasting models based on an actual load of each of the plurality of normalized test sets and the total forecasting result. After each of the plurality of first forecasting models is optimized, a corresponding second forecasting model is obtained.

In some embodiments, after the optimal coordination matrix G and an optimal parameter \hat{θ}=(\hat{θ}^{[1]}, . . . , \hat{θ}^{[k]}) of the carbon emission factor forecasting model at each time granularity are obtained, the carbon emission factor forecasting is performed on the test set

$${D}_{i}^{test}$$

at each time granularity, and coordination is performed to obtain a coordinated total forecasting result \tilde{y}ₜₑₛₜ, which can be decomposed into a forecasting result

$${\tilde{y}}_{test}^{[ 1 ]} , … , {\tilde{y}}_{test}^{[ k ]}$$

at each time granularity based on a time hierarchy.

In some embodiments, the evaluating forecasting precision of each of the second forecasting models includes: taking a MAPE as an evaluation indicator of the forecasting precision of the second forecasting model, where the evaluation indicator is expressed as follows:

$$MAPE ( {\tilde{y}}^{[ i ]} , {y}^{[ i ]} ) = \frac{1}{\vert {D}_{i}^{test} \vert \cdot T} {\sum }_{j = 1}^{\vert {D}_{i}^{test} \vert} {\sum }_{t = 1}^{T} \vert \frac{{y}_{j , t}^{[ i ]} - {\tilde{y}}_{j , t}^{[ i ]}}{{y}_{j , t}^{[ i ]}} \vert \times 100 \% ,$$

where

j represents a serial number of a test sample, t represents a serial number of a time point in the to-be-forecast time period,

$${\tilde{y}}_{j , t}^{[ i ]}$$

represents a forecasting result of the normalized test set,

$${y}_{j , t}^{[ i ]}$$

represents an actual load corresponding to the test sample,

$$\vert {D}_{i}^{test} \vert$$

represents a quantity of test set samples of an i^{th} second forecasting model, and T represents a total quantity of time points in the to-be-forecast time period.

It is worth noting that a smaller value of the MAPE leads to higher precision of the carbon emission factor forecasting. Thus, carbon emission factor forecasting results at the k time granularities can be evaluated.

Since the carbon emission factor serves as an indicator for quantifying and evaluating a carbon emission level, in order to control carbon emission of factories, enterprises, and organizations, an operating state of a factory in the to-be-forecast region is controlled based on a forecasted carbon emission factor.

In some embodiments, the generating a corresponding control instruction based on a comparison result includes:
when the forecasted carbon emission factor is greater than a first threshold, generating a first device shutdown instruction for controlling a production device with an energy consumption greater than an energy consumption threshold in the to-be-forecast region to stop operating; or when the forecasted carbon emission factor is less than a second threshold, generating a full-load operation instruction for controlling all production devices in the to-be-forecast region to operate at a full load.

In some embodiments, first of all, a system compares a forecast value of the forecasted carbon emission factor with a preset threshold. For example, for a carbon emission factor of clinker produced by a cement plant in a region, a management threshold can be set based on a national carbon market quota allocation scheme: The first threshold (warning threshold) is set to 0.8 tCO₂/t clinker, and the second threshold (safe threshold) is set to 0.7 tCO₂/t clinker.

Subsequently, a control instruction is generated based on a comparison result. If the forecast value is greater than 0.8 tCO₂/t clinker, it indicates that a carbon emission intensity in the region will be severe in a coming time period. The system then generates a “production restriction” instruction, such as the first device shutdown instruction. This instruction is sent to a supervisory control and data acquisition (SCADA) system or a distributed control system (DCS) of a key emission enterprise in the region through an industrial data bus (such as an object linking and embedding (OLE) for process control (OPC) unified architecture (UA)) to forcibly reduce operating loads of some high-energy-consumption production lines (such as electrolytic aluminum and cement clinker production lines), for instance, lower a production capacity by 10% to 20%. If the forecast value is less than 0.7 tCO₂/t clinker, it indicates that an environmental capacity is sufficient. The system can generate a “production allowance” instruction, such as the full-load operation instruction, to revoke the previous production restriction instruction and allow the factory to resume operation at an optimal economic load. The first threshold and the second threshold are set based on a carbon emission policy and regulation implemented in the to-be-forecast region.

The carbon emission factor forecasting method based on multi-time granularity data coordination provided in this embodiment can efficiently utilize data of different time granularities to construct a coordinated and high-performance carbon emission factor forecasting model, thereby laying a foundation for perception and analysis of changing trends of the carbon emission factor at different time scales.

### Embodiment 2

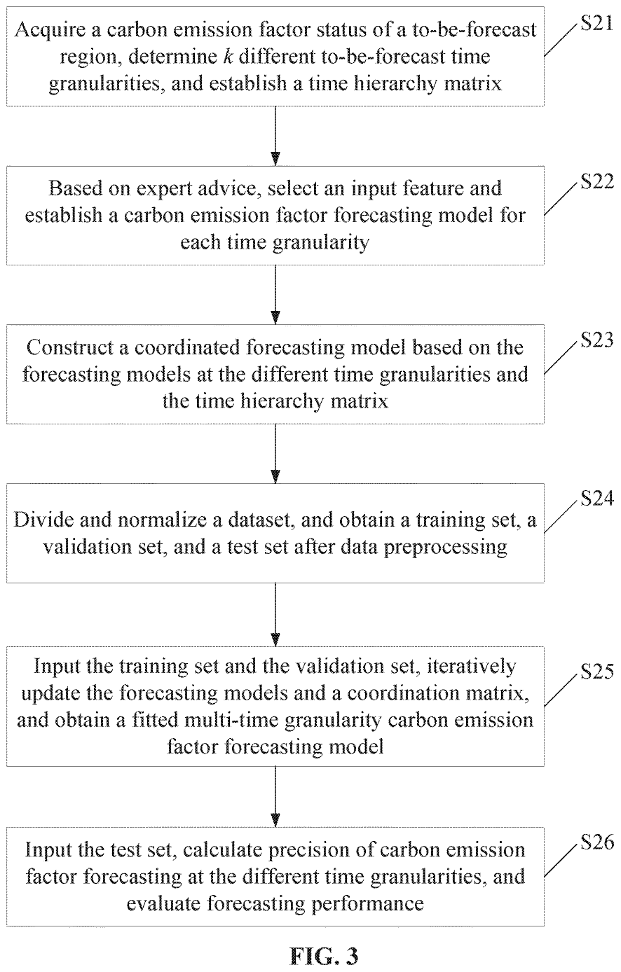

FIG. 3 is a complete schematic flowchart of a carbon emission factor forecasting method based on multi-time granularity data coordination according to this embodiment. The carbon emission factor forecasting method specifically includes the following steps S21 to S26:

Step S21: Acquire a carbon emission factor status of a to-be-forecast region, determine k different to-be-forecast time granularities, and establish a time hierarchy matrix.

Step S22: Based on expert advice, select an input feature and establish a carbon emission factor forecasting model f₁, . . . , fₖ for each time granularity.

Step S23: Construct a coordinated forecasting model G based on the forecasting models at the different time granularities and the time hierarchy matrix.

Step S24: Divide and normalize a dataset, and obtain a training set, a validation set, and a test set after data preprocessing.

Step S25: Input the training set and the validation set, iteratively update the forecasting models and a coordination matrix, and obtain a fitted multi-time granularity carbon emission factor forecasting model. Substeps S251 and S252 are specifically included:

Substep S251: Separately define a training set loss function

$${ℒ}_{i}^{train}$$

and a validation set loss function [symbol] ^{val}, and establish a bi-level optimization model:

$${min}_{G} {ℒ}^{val} ( \hat{θ} ( G ) ) \\ s . t . \\ \hat{θ} ( G ) = arg {min}_{{θ}^{[ 1 ]} , … , {θ}^{[ k ]}} {ℒ}^{train} ( {θ}^{[ 1 ]} , … , {θ}^{[ k ]} , G ) .$$

Substep S252: To train the forecasting models, employ a gradient descent method to iteratively update a model parameter θ and the coordination matrix G, thereby obtaining an optimal coordination matrix Ĝ as well as an optimal parameter \hat{θ}=(\hat{θ}^{[1]}, . . . , \hat{θ}^{[k]}) of a carbon emission factor forecasting model at each time granularity.

Step S26: Input the test set, calculate precision of carbon emission factor forecasting at the different time granularities, and evaluate forecasting performance. A MAPE is used as an indicator for evaluating forecasting precision of an i^{th} time granularity. A forecasting result

$${\tilde{y}}_{test}^{[ i ]}$$

and an actual load

$${y}_{test}^{[ 1 ]}$$

are substituted into the following formula for calculation:

$$MAPE ( {\tilde{y}}^{[ i ]} , {y}^{[ i ]} ) = \frac{1}{\vert {D}_{i}^{test} \vert \cdot T} {\sum }_{j = 1}^{\vert {D}_{i}^{test} \vert} {\sum }_{t = 1}^{T} \vert \frac{{y}_{j , t}^{[ i ]} - {\tilde{y}}_{j , t}^{[ i ]}}{{y}_{j , t}^{[ i ]}} \vert \times 100 \% .$$

A smaller value of the MAPE leads to higher precision of the carbon emission factor forecasting. Thus, carbon emission factor forecasting results at k time granularities can be evaluated.

This embodiment separately establishes one forecasting model for each different time granularity, which can improve a utilization rate of multivariate time-series data. Furthermore, based on the time granularity and the to-be-forecast time period, the time hierarchy matrix is constructed to fuse a plurality of forecasting models. This can aggregate different fine-grained forecasting results, enhance an implicit impact of a coupling relationship among time hierarchies on the carbon emission factor forecasting, and build a self-consistent and coordinated carbon emission factor forecasting model. Therefore, consistent multi-time-hierarchy forecasting results can be formed, thereby improving the precision of the carbon emission factor forecasting and laying a foundation for perception and analysis of changing trends of a carbon emission factor at different time scales.

### Embodiment 3

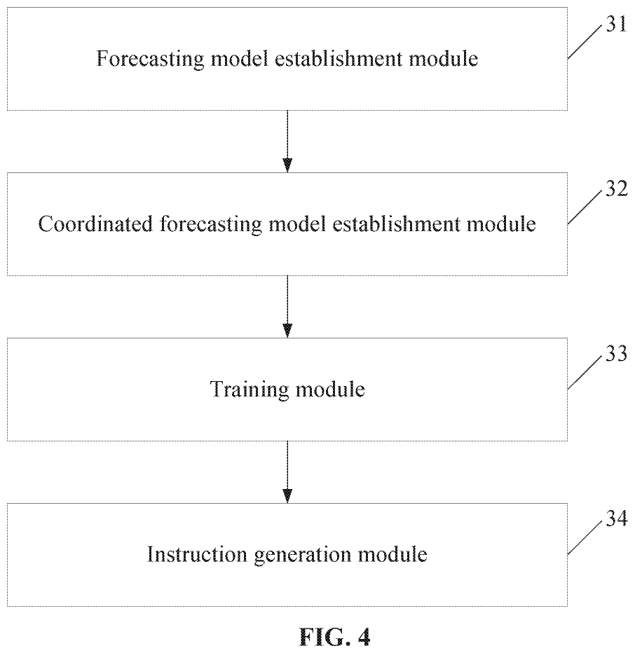

FIG. 4 is a schematic structural diagram of a carbon emission factor forecasting system based on multi-time granularity data coordination according to this embodiment, including: a forecasting model establishment module 31, a coordinated forecasting model establishment module 32, a training module 33, and an instruction generation module 34.

It is worth noting that the forecasting model establishment module 31 mainly divides carbon emission data based on a time granularity, establishes one forecasting model for each time granularity, and transmits a quantity of time granularities and a plurality of forecasting models to the coordinated forecasting model establishment module 32. After receiving the time granularities and the plurality of forecasting models, the coordinated forecasting model establishment module 32 establishes a time hierarchy matrix in combination with a to-be-forecast time period, fuses the plurality of forecasting models based on the time hierarchy matrix to establish a coordinated forecasting model, and transmits the coordinated forecasting model to the training module 33. The training module 33 trains the received coordinated forecasting model and uses a trained coordinated forecasting model to perform coordinated forecasting on a carbon emission factor.

The forecasting model establishment module 31 is configured to acquire first carbon emission data of a to-be-forecast region, and establish, based on a time granularity of the first carbon emission data, a plurality of initial first forecasting models for carbon emission factor forecasting, where each time granularity corresponds to one first forecasting model.

In some embodiments, the time hierarchy matrix is established based on the time granularity and the to-be-forecast time period, which includes: if the time granularity includes an annual granularity, a quarterly granularity, and a monthly granularity, there are k=3 time granularities; and if the to-be-forecast time period is next 12 months, the time hierarchy matrix is expressed as follows:

$$S = {( \begin{matrix}{S}_{Y} \\ {S}_{Q} \\ {S}_{M}\end{matrix} )}_{17 \times 12} \\ where$$

$${S}_{Y} = \frac{1}{12} {( 1 , … , 1 )}_{1 \times 12} ; \\ {S}_{Q} = \frac{1}{4} {( \begin{matrix}{1}_{4} & 0 & 0 \\ 0 & ⋱ & 0 \\ 0 & 0 & {1}_{4}\end{matrix} )}_{4 \times 12} ,$$

where 1₄=(1, . . . , 1)_{1×4}; and S_{M}=I_{12×12}, where I represents an identity matrix.

The coordinated forecasting model establishment module 32 is configured to establish the time hierarchy matrix based on the time granularity and the to-be-forecast time period, and fuse the plurality of first forecasting models based on the time hierarchy matrix to obtain an initial first coordinated forecasting model.

In some embodiments, the fusing the plurality of first forecasting models based on the time hierarchy matrix to obtain an initial first coordinated forecasting model includes: constructing an initial coordination matrix based on a quantity of forecast carbon emission factor values at a finest time granularity, acquiring an output matrix constituted by outputs of the plurality of first forecasting models, and constructing the initial first coordinated forecasting model in a dot product sequence of the time hierarchy matrix, the initial coordination matrix, and the output matrix.

In some embodiments, the constructing an initial coordination matrix based on a quantity of forecast carbon emission factor values at a finest time granularity includes: constructing an identity matrix based on the quantity of forecast carbon emission factor values at the finest time granularity, constructing a zero matrix with the quantity of forecast carbon emission factor values as a row and a difference between a total quantity of forecast carbon emission factor values at all time granularities and the quantity of forecast carbon emission factor values as a column, and taking a block matrix constituted by the zero matrix and the identity matrix as the initial coordination matrix.

The training module 33 is configured to update a parameter of the first coordinated forecasting model based on the first carbon emission data, and obtain a trained second coordinated forecasting model, so as to forecast the carbon emission factor through the second coordinated forecasting model.

The instruction generation module 34 is configured to compare the carbon emission factor with a preset threshold range, generate a corresponding control instruction based on a comparison result, and issue the corresponding control instruction to a factory control system in the to-be-forecast region through an industrial control interface, so as to adjust an operating state of a production device in the to-be-forecast region.

In some embodiments, the updating a parameter of the first coordinated forecasting model based on the first carbon emission data includes: sequentially dividing second carbon emission data of the plurality of first forecasting models into a training set and a validation set proportionally, where the first carbon emission data includes second carbon emission data corresponding to each of the plurality of first forecasting models; and updating an initial parameter of the first coordinated forecasting model and an initial coordination matrix based on the training set, the validation set, and a pre-constructed bi-level optimization model, where the bi-level optimization model includes a lower-level optimization model and an upper-level optimization model, the lower-level optimization model optimizes the initial parameter based on the training set to obtain an optimal parameter, and the upper-level optimization model optimizes the initial coordination matrix based on the validation set and the optimal parameter.

In some embodiments, the bi-level optimization model is expressed as follows:

$${min}_{G} {ℒ}^{val} ( \hat{θ} ( G ) ) \\ s . t . \\ \hat{θ} ( G ) = arg {min}_{{θ}^{[ 1 ]} , … , {θ}^{[ k ]}} {ℒ}^{train} ( {θ}^{[ 1 ]} , … , {θ}^{[ k ]} , G ) ,$$

where

$${ℒ}^{train} ( {θ}^{[ 1 ]} , … , {θ}^{[ k ]} , G ) = \frac{1}{\vert {D}_{i}^{train} \vert} {\sum }_{j = 1}^{\vert {D}_{i}^{train} \vert} {‖ {y}_{j , 1} - {\tilde{y}}_{1} ‖}_{2}^{2}$$

represents the lower-level optimization model;

$$\vert {D}_{i}^{train} \vert$$

represents a quantity of training set samples of an i^{th} first forecasting model, where i∈[1, k]; y_{j,1} represents an actual load of a j^{th} training sample; G represents the initial coordination matrix; \hat{θ}=(\hat{θ}^{[1]}, . . . , \hat{θ}^{[k]}) represents an initial parameter set of a k^{th} first forecasting model; \tilde{y}₁ represents a forecasting result obtained by inputting the training set into the first coordinated forecasting model;

$${ℒ}^{val} ( \hat{θ} ( G ) ) = \frac{1}{\vert {D}_{i}^{val} \vert} {\sum }_{j = 1}^{\vert {D}_{i}^{val} \vert} {‖ {y}_{j , 2} - {\tilde{y}}_{2} ‖}_{2}^{2}$$

represents the upper-level optimization model; \tilde{y}₂ represents a forecasting result obtained by inputting a test set into the first coordinated forecasting model;

$$\vert {D}_{i}^{val} \vert$$

represents a quantity of validation set samples of the i^{th} first forecasting model; and y_{j,2} represents an actual load of a j^{th} validation sample.

In some embodiments, the sequentially dividing second carbon emission data of the plurality of first forecasting models into a training set and a validation set proportionally includes: sequentially performing feature screening on the second carbon emission data of the plurality of first forecasting models, obtaining a feature screening result, dividing the feature screening result into a training set, a validation set, and a test set proportionally, and performing column-wise normalization on the training set, the validation set, and the test set to obtain a normalized training set, a normalized validation set, and a normalized test set respectively, so as to finally perform training, validation, and testing based on the normalized training set, the normalized validation set, and the normalized test set respectively, where each of the plurality of first forecasting models corresponds to one normalized training set, one normalized validation set, and one normalized test set.

In some embodiments, the performing testing based on the normalized test set includes: respectively inputting a plurality of normalized test sets into corresponding second forecasting models after optimization of the plurality of first forecasting models, respectively outputting corresponding forecasting results based on optimal parameters obtained after the optimization, inputting the forecasting results into the second coordinated forecasting model, and outputting a total forecasting result based on an optimal coordination matrix obtained after the optimization; and evaluating forecasting precision of each of the second forecasting models based on an actual load of each of the plurality of normalized test sets and the total forecasting result.

In some embodiments, the evaluating forecasting precision of each of the second forecasting models includes: taking a MAPE as an evaluation indicator of the forecasting precision of the second forecasting model, where the evaluation indicator is expressed as follows:

$$MAPE ( {\tilde{y}}^{[ i ]} , {y}^{[ i ]} ) = \frac{1}{\vert {D}_{i}^{test} \vert \cdot T} {\sum }_{j = 1}^{\vert {D}_{i}^{test} \vert} {\sum }_{t = 1}^{T} \vert \frac{{y}_{j , t}^{[ i ]} - {\tilde{y}}_{j , t}^{[ i ]}}{{y}_{j , t}^{[ i ]}} \vert \times 100 \% ,$$

where

j represents a serial number of a test sample, t represents a serial number of a time point in the to-be-forecast time period,

$${\tilde{y}}_{j , t}^{[ i ]}$$

represents a forecasting result of the normalized test set,

$${y}_{j , t}^{[ i ]}$$

represents an actual load corresponding to the test sample,

$$\vert {D}_{i}^{test} \vert$$

represents a quantity of test set samples of an i^{th} second forecasting model, and T represents a total quantity of time points in the to-be-forecast time period. This embodiment adopts the forecasting model establishment module 31 to separately establish one forecasting model for each different time granularity, which can improve a utilization rate of multivariate time-series data. Furthermore, the coordinated forecasting model establishment module 32 is adopted to establish the time hierarchy matrix based on the time granularity and the to-be-forecast time period to fuse the plurality of forecasting models. This can aggregate different fine-grained forecasting results, enhance an implicit impact of a coupling relationship among time hierarchies on the carbon emission factor forecasting, and build a self-consistent and coordinated carbon emission factor forecasting model. The training module 33 performs training to form optimal and consistent multi-time-hierarchy forecasting results, thereby improving precision of the carbon emission factor forecasting and laying a foundation for perception and analysis of changing trends of the carbon emission factor at different time scales.

In another implementation example, the above carbon emission factor forecasting system based on multi-time granularity data coordination includes a processor configured to execute the above program modules stored in a memory, including the forecasting model establishment module 31, the coordinated forecasting model establishment module 32, the training module 33, and the instruction generation module 34.

Those skilled in the art should understand that the embodiments of the present disclosure may be provided as a computer program product. Therefore, the present disclosure may use a form of hardware-only embodiments, software-only embodiments, or embodiments with a combination of software and hardware. Moreover, the present disclosure may use a form of a computer program product that is implemented on one or more computer-usable storage media (including but not limited to a disk memory, a compact disc read-only memory (CD-ROM), an optical memory, and the like) that include computer-usable program code.

The present disclosure is described with reference to flowcharts and/or block diagrams of the method, the device (system), and the computer program product according to the embodiments of the present disclosure. It should be understood that each process and/or each block in the flowcharts and/or the block diagrams and a combination of a process and/or a block in the flowcharts and/or the block diagrams can be implemented by computer program instructions. These computer program instructions may be provided for a general-purpose computer, a dedicated computer, an embedded processor, or a processor of another programmable data processing device to generate a machine, such that the instructions executed by a computer or a processor of another programmable data processing device generate an apparatus for implementing a specific function in one or more processes in the flowcharts and/or one or more blocks in the block diagrams.

These computer program instructions may also be stored in a computer readable memory that can guide a computer or another programmable data processing device to work in a specific manner, such that the instructions stored in the computer readable memory produce an artifact that includes an instruction apparatus, and the instruction apparatus implements a specified function in one or more processes in the flowcharts and/or one or more blocks in the block diagrams.

These computer program instructions may also be loaded onto a computer or another programmable data processing device, such that a series of operating steps are performed on the computer or the another programmable device to generate computer-implemented processing, and the instructions executed on the computer or the another programmable device provide steps for implementing a specific function in one or more processes in the flowcharts and/or one or more blocks in the block diagrams.

The above described are preferred implementations of the present disclosure, and it should be noted that for those of ordinary skill in the art, various improvements and modifications may be made without departing from the principles of the present disclosure. These improvements and modifications should be regarded as falling within the protection scope of the present disclosure.

1. A carbon emission factor forecasting method based on multi-time granularity data coordination, comprising:
acquiring first carbon emission data of a to-be-forecast region, and establishing, based on a time granularity of the first carbon emission data, a plurality of initial first forecasting models for carbon emission factor forecasting, wherein each time granularity corresponds to one first forecasting model;
establishing a time hierarchy matrix based on the time granularity and a to-be-forecast time period, and fusing the plurality of first forecasting models based on the time hierarchy matrix to obtain an initial first coordinated forecasting model;
updating a parameter of the first coordinated forecasting model based on the first carbon emission data, and obtaining a trained second coordinated forecasting model, to forecast a carbon emission factor through the second coordinated forecasting model; and
comparing the carbon emission factor with a preset threshold range, generating a corresponding control instruction based on a comparison result, and issuing the corresponding control instruction to a factory control system in the to-be-forecast region through an industrial control interface, to adjust an operating state of a production device in the to-be-forecast region.

2. The carbon emission factor forecasting method according to claim 1, wherein the generating a corresponding control instruction based on a comparison result comprises:
in response to that the forecasted carbon emission factor is greater than a first threshold, generating a first device shutdown instruction for controlling a production device with an energy consumption greater than an energy consumption threshold in the to-be-forecast region to stop operating; or in response to that the forecasted carbon emission factor is less than a second threshold, generating a full-load operation instruction for controlling all production devices in the to-be-forecast region to operate at a full load.

3. The carbon emission factor forecasting method based on multi-time granularity data coordination according to claim 1, wherein the fusing the plurality of first forecasting models based on the time hierarchy matrix to obtain an initial first coordinated forecasting model comprises:
constructing an initial coordination matrix based on a quantity of forecast carbon emission factor values at a finest time granularity, acquiring an output matrix constituted by outputs of the plurality of first forecasting models, and constructing the initial first coordinated forecasting model in a dot product sequence of the time hierarchy matrix, the initial coordination matrix, and the output matrix.

4. The carbon emission factor forecasting method based on multi-time granularity data coordination according to claim 3, wherein the constructing an initial coordination matrix based on a quantity of forecast carbon emission factor values at a finest time granularity comprises:
constructing an identity matrix based on the quantity of forecast carbon emission factor values at the finest time granularity, constructing a zero matrix with the quantity of forecast carbon emission factor values as a row and a difference between a total quantity of forecast carbon emission factor values at all time granularities and the quantity of forecast carbon emission factor values as a column, and taking a block matrix constituted by the zero matrix and the identity matrix as the initial coordination matrix.

5. The carbon emission factor forecasting method based on multi-time granularity data coordination according to claim 1, wherein the establishing a time hierarchy matrix based on the time granularity and a to-be-forecast time period comprises:
in response to that the time granularity comprises an annual granularity, a quarterly granularity, and a monthly granularity, there are 3 time granularities; and in response to that the to-be-forecast time period is next 12 months, the time hierarchy matrix is expressed as follows:
$$S = {( \begin{matrix}{S}_{Y} \\ {S}_{Q} \\ {S}_{M}\end{matrix} )}_{17 \times 12}$$
wherein
$${S}_{Y} = \frac{1}{12} {( 1 , … , 1 )}_{1 \times 12} ;$$
$${S}_{Q} = \frac{1}{4} {( \begin{matrix}{1}_{4} & 0 & 0 \\ 0 & ⋱ & 0 \\ 0 & 0 & {1}_{4}\end{matrix} )}_{4 \times 12} ,$$
1₄=(1, . . . , 1)_{1×4}; and S_{M}=I_{12×12}, wherein I represents an identity matrix.

6. The carbon emission factor forecasting method based on multi-time granularity data coordination according to claim 1, wherein the updating a parameter of the first coordinated forecasting model based on the first carbon emission data comprises:
sequentially dividing second carbon emission data of the plurality of first forecasting models into a training set and a validation set proportionally, wherein the first carbon emission data comprises second carbon emission data corresponding to each of the plurality of first forecasting models; and
updating an initial parameter of the first coordinated forecasting model and an initial coordination matrix based on the training set, the validation set, and a pre-constructed bi-level optimization model, wherein the bi-level optimization model comprises a lower-level optimization model and an upper-level optimization model, the lower-level optimization model optimizes the initial parameter based on the training set to obtain an optimal parameter, and the upper-level optimization model optimizes the initial coordination matrix based on the validation set and the optimal parameter.

7. The carbon emission factor forecasting method based on multi-time granularity data coordination according to claim 6, wherein the bi-level optimization model is expressed as follows:
$${min}_{G} {ℒ}^{val} ( \hat{θ} ( G ) )$$
$$s . t . \hat{θ} ( G ) = arg {min}_{{θ}^{[ 1 ]} , … , {θ}^{[ k ]}} {ℒ}^{train} ( {\hat{θ}}^{[ 1 ]} , … , {\hat{θ}}^{[ k ]} , G ) ,$$
wherein
$${ℒ}^{train} ( {\hat{θ}}^{[ 1 ]} , … , {\hat{θ}}^{[ k ]} , G ) = \frac{1}{\vert {D}_{i}^{train} \vert} {\sum }_{j = 1}^{\vert {D}_{i}^{train} \vert} {‖ {y}_{j , 1} - {\tilde{y}}_{1} ‖}_{2}^{2}$$
represents the lower-level optimization model;
$$\vert {D}_{i}^{train} \vert$$
represents a quantity of training set samples of an i^{th} first forecasting model, wherein i=1, 2, . . . , k; y_{j,1} represents an actual load of a j^{th} training sample; G represents the initial coordination matrix; \hat{θ}=(\hat{θ}^{[1]}, . . . , \hat{θ}^{[k]}) represents an initial parameter set of a k^{th} first forecasting model; \tilde{y}₁ represents a forecasting result obtained by inputting the training set into the first coordinated forecasting model;
$${ℒ}^{val} ( \hat{θ} ( G ) ) = \frac{1}{\vert {D}_{i}^{val} \vert} {\sum }_{j = 1}^{\vert {D}_{i}^{val} \vert} {‖ {y}_{j , 2} - {\tilde{y}}_{2} ‖}_{2}^{2}$$
represents the upper-level optimization model; \tilde{y}₂ represents a forecasting result obtained by inputting a test set into the first coordinated forecasting model;
$$\vert {D}_{i}^{v a l} \vert$$
represents a quantity of validation set samples of the i^{th} first forecasting model; and y_{j,2} represents an actual load of a j^{th} validation sample.

8. The carbon emission factor forecasting method based on multi-time granularity data coordination according to claim 6, wherein the sequentially dividing second carbon emission data of the plurality of first forecasting models into a training set and a validation set proportionally comprises:
sequentially performing feature screening on the second carbon emission data of the plurality of first forecasting models, obtaining a feature screening result, dividing the feature screening result into a training set, a validation set, and a test set proportionally, and performing column-wise normalization on the training set, the validation set, and the test set to obtain a normalized training set, a normalized validation set, and a normalized test set respectively, to finally perform training, validation, and testing based on the normalized training set, the normalized validation set, and the normalized test set respectively, wherein each of the plurality of first forecasting models corresponds to one normalized training set, one normalized validation set, and one normalized test set.

9. The carbon emission factor forecasting method based on multi-time granularity data coordination according to claim 8, wherein the performing testing based on the normalized test set comprises:
respectively inputting a plurality of normalized test sets into corresponding second forecasting models after optimization of the plurality of first forecasting models, respectively outputting corresponding forecasting results based on optimal parameters obtained after the optimization, inputting the forecasting results into the second coordinated forecasting model, and outputting a total forecasting result based on an optimal coordination matrix obtained after the optimization; and
evaluating forecasting precision of each of the second forecasting models based on an actual load of each of the plurality of normalized test sets and the total forecasting result.

10. The carbon emission factor forecasting method based on multi-time granularity data coordination according to claim 9, wherein the evaluating forecasting precision of each of the second forecasting models comprises:
taking a mean absolute percentage error (MAPE) as an evaluation indicator of the forecasting precision of the second forecasting model, wherein the evaluation indicator is expressed as follows:
$$MAPE ( {\tilde{y}}^{[ i ]} , {y}^{[ i ]} ) = \frac{1}{\vert {D}_{i}^{test} \vert \cdot T} {\sum }_{j = 1}^{\vert {D}_{i}^{test} \vert} {\sum }_{t = 1}^{T} \vert \frac{{y}_{j , t}^{[ i ]} - {\tilde{y}}_{j , t}^{[ i ]}}{{y}_{j , t}^{[ i ]}} \vert \times 100 \% ,$$
wherein
j represents a serial number of a test sample, t represents a serial number of a time point in the to-be-forecast time period,
$${\tilde{y}}_{j , t}^{[ i ]}$$
represents a forecasting result of the normalized test set,
$${y}_{j , t}^{[ i ]}$$
represents an actual load corresponding to the test sample,
$$\vert {D}_{i}^{test} \vert$$
represents a quantity of test set samples of an i^{th} second forecasting model, and T represents a total quantity of time points in the to-be-forecast time period.

11. A carbon emission factor forecasting system based on multi-time granularity data coordination, comprising: a forecasting model establishment module, a coordinated forecasting model establishment module, a training module, and an instruction generation module, wherein the forecasting model establishment module is configured to acquire first carbon emission data of a to-be-forecast region, and establish, based on a time granularity of the first carbon emission data, a plurality of initial first forecasting models for carbon emission factor forecasting, wherein each time granularity corresponds to one first forecasting model;
the coordinated forecasting model establishment module is configured to establish a time hierarchy matrix based on the time granularity and a to-be-forecast time period, and fuse the plurality of first forecasting models based on the time hierarchy matrix to obtain an initial first coordinated forecasting model;
the training module is configured to update a parameter of the first coordinated forecasting model based on the first carbon emission data, and obtain a trained second coordinated forecasting model, to forecast a carbon emission factor through the second coordinated forecasting model; and
the instruction generation module is configured to compare the carbon emission factor with a preset threshold range, generate a corresponding control instruction based on a comparison result, and issue the corresponding control instruction to a factory control system in the to-be-forecast region through an industrial control interface, to adjust an operating state of a production device in the to-be-forecast region.
